(19) United States
(12) Patent Application Publication
(10) Pub. No.: US 2024/0169235 A1
(43) Pub. Date: May 23, 2024

(54) Method and System for Quantum Chemistry Modelling

(71) Applicant: Xanadu Quantum Technologies Inc., Toronto (CA)

(72) Inventors: Juan Miguel Arrazola, Toronto (CA); Roberto Dos Reis, Chicago, IL (US)

(21) Appl. No.: 18/453,424

(22) Filed: Aug. 22, 2023

Related U.S. Application Data
(60) Provisional application No. 63/400,247, filed on Aug. 23, 2022.

(51) Int. Cl. G06N 10/20; G06N 10/60

(52) U.S. Cl. CPC G06N 10/20; G06N 10/60

(57) ABSTRACT

There is described a hybrid quantum-classical computing method and system that leverages quantum processing to generate data that enables the training of neural networks for the purpose of density functional theory (DFT) functional determination. Physical systems are modeled on a quantum processing module and simulated to generate energy values and electronic density functions as training data with sufficient degrees of quality and accuracy. The training data may be in classical form and are used to train a neural network. The trained neural network may then be employed to parameterize DFT functionals.

### CROSS-REFERENCE TO RELATED APPLICATIONS

This application claims priority to, and the benefit of, U.S. Provisional Patent Application No. 63/400,247, filed on Aug. 23, 2022 and titled “Method and System for Quantum Chemistry Modelling,” the entire content of which is incorporated by reference herein in its entirety.

### BACKGROUND OF THE INVENTION

The present application relates to quantum processing, and in particular to facilitating quantum chemistry modelling using quantum processing modules.

Density functional theory (DFT) is in principle an exact approach for quantum chemistry modelling. However, DFT relies on the ability to obtain an exact expression for the so-called universal functional. Deriving this exact expression has yet to be achieved.

Instead, DFT practitioners utilize approximations to the universal functional based on several heuristics as well as physical and chemical insights. This makes DFT an approximation method in practice, which works well in some situations yet struggles to produce accurate results, or even incurs significant errors, in many others. Further, when dealing with strongly correlated systems involving hundreds or thousands of electrons, conventional computational methods designed for classical computing systems incur significant, and often impractical, computational costs in terms of computational resources and computational time.

Hence, there have been continued efforts dedicated to improving DFT accuracy. Historically, these efforts have primarily relied on human expertise and intuition, but such methods have begun to saturate with few improvements in recent years. With the advent of machine learning and its application to material science, a new approach to improve DFT accuracy involves leveraging machine learning techniques that are trained on data obtained from experiments or classical simulations. However, such methods suffer from a lack of data of sufficient accuracy and quality. Specifically, experimental data is often noisy and very expensive to produce, while only addressing systems that are easy to study under laboratory conditions. On the other hand, nearly all methods involving classical simulation fail to produce sufficiently accurate values for larger physical systems due to their reliance on approximations, causing the resulting trained machine learning model to suffer from similar inaccuracies.

Accordingly, it is desirable to provide an improved method and system of DFT determination that at least partially addresses some of the issues that plague the current methods.

### SUMMARY OF THE INVENTION

In one aspect, there is provided a hybrid quantum-classical computing method and system that leverages quantum processing to generate data that enables the training of neural networks for the purpose of DFT functional determination. Specifically, physical systems may be modelled on a quantum processing unit and simulated to generate ground-state energy values as classical data with relatively high degrees of quality and accuracy. The classical data may be used as training data to train a neural network. The trained neural network may be employed to parameterize DFT functionals with improved accuracy and greater efficiency compared to existing DFT determination methods.

Examples of the present disclosure may enable modelling and simulation of large and complex physical systems, or even systems which are theoretical in nature, such that accurate modelling and simulation on a classical computing system is impractical or even impossible. Examples of the present disclosure are capable of harnessing the computational power of quantum processing modules to model and simulate such physical systems with sufficient degrees of accuracy and quality required to train a neural network.

In another aspect, the present disclosure provides a flexible approach to determine DFT functionals where a neural network may be trained for a wide range of physical systems with diverse physical and quantum-mechanical properties and still provide accurate DFT functional parameterizations. Varying the input parameters to the quantum processing module is a much easier and faster way to produce a wide variety of training data compared to experimental measurements. A wide variety of training data is advantageous because it allows the trained machine learning model to deal accurately with a wider range of inputs when used.

According to a first example aspect, there is a method comprising: receiving, at a density functional theory (DFT) functional module, an electronic density of a physical system; and determining, by the DFT functional module, from the electronic density, parameters of a DFT functional that model one or more aspects of the physical system, wherein the DFT functional module is trained using training data, the training data including classical data generated from a quantum processing module.

According to a second example aspect, there is a system comprising: a quantum processing module configured to generate classical data for training a density functional theory (DFT) functional module; and a classical processing module configured to generate, by providing an electronic density of a physical system as input to the DFT functional module, parameters of a DFT functional that are used to model one or more aspects of the physical system.

In any of the above aspects, the training data may include a data pair comprising a training electronic density and a training exchange-correlation energy.

In any of the above aspects, the generating of the classical data by the quantum processing module may further include: constructing a Hamiltonian of the physical system; mapping fermionic operators of the Hamiltonian to qubit operators; constructing, from the qubit operators, a set of unitaries; applying the set of unitaries in accordance with a quantum algorithm onto one or more qubit registers; and generating the classical data.

In any of the above aspects, the classical data may include one or more of an electronic density function, a total system energy, a classical shadow, and a reduced density matrix.

Any of the above aspects may further include approximating the DFT functional using a Kohn-Sham method, wherein the DFT functional is parameterized using a hybrid functional construction.

In any of the above aspects, the hybrid functional construction may be one of an internal method where the DFT functional, represented by E_{XC}, is expressed as

$${E}_{XC} = \int {\sum }_{i = 1}^{N} {c}_{i} {E}^{( i )} [ n ] ( r ) {d}^{3} r$$

and an external method where the DFT functional is expressed as

$${E}_{XC} = {\sum }_{i = 1}^{N} {c}_{i} \int {E}^{( i )} [ n ] ( r ) {d}^{3} r = {\sum }_{i = 1}^{N} {c}_{i} {E}^{( i )} ,$$

wherein the coefficients cᵢ are the parameters of the DFT functional.

In any of the above aspects, the Hamiltonian may be constructed based on one of a first quantization formalism and a second quantization formalism.

In any of the above aspects, the Hamiltonian may be constructed based on the second quantization formalism, and the fermionic operator to qubit operator mapping may be based on a Jordan-Wigner transformation.

In any of the above aspects, the quantum algorithm may be any one of quantum phase estimation, variational quantum eigensolver (VQE), adiabatic quantum algorithm, Krylov subspace method, and imaginary-time evolution.

In any of the above aspects, the quantum algorithm may be quantum phase estimation, and the applying may further include: preparing at least one auxiliary qubit in an equal superposition state; applying each unitary U of the set of unitaries in the form of U²^{^{t}}, where t is the number of the at least one auxiliary qubit, onto each of the at least one auxiliary qubit; applying an inverse quantum Fourier transform on each of the at least one auxiliary qubit; measuring each of the at least one auxiliary qubit in a computational basis to generate an output bit string; estimating a phase value based on the output bit string; and determining a ground-state energy value based on the estimated phase value.

In any of the above aspects, the training of the DFT functional module may further include iteratively performing: sampling the training data, obtaining a predicted exchange-correlation energy based on the training electronic density, calculating a loss value between the predicted exchange-correlation energy and the training exchange-correlation energy, and updating a weight matrix of the DFT functional module based on the loss value; and storing the updated weight matrix of the DFT functional module.

In any of the above aspects, the DFT functional module may be a trained deep neural network.

In any of the above aspects, the parameters of the DFT functional may be weights of the trained deep neural network.

In any of the above aspects, the quantum processing module may be based on any one of superconducting qubits, photonic qubits, trapped-ion qubits, silicon-based qubits, and neutral-atom-based qubits.

### BRIEF DESCRIPTION OF THE DRAWINGS

Reference will now be made, by way of example, to the accompanying figures which show example embodiments of the present application, and in which:

FIG. 1 illustrates a block diagram showing an example system, in accordance with some embodiments of the present disclosure;

FIG. 2 illustrates a block diagram of an example hardware structure of a neural network processor according to an embodiment of the present disclosure;

FIG. 3 illustrates a flowchart of an example method that may be executed by system 100 of FIG. 1 in accordance with embodiments of the present disclosure;

FIG. 4 illustrates a flowchart of an example method for generating classical data in accordance with exemplary embodiments of the present disclosure; and

FIG. 5 illustrates a flowchart of an example method for training a DFT module in accordance with exemplary embodiments of the present disclosure;

Like reference numerals are used throughout the figures to denote similar elements and features. While aspects of the invention will be described in conjunction with the illustrated embodiments, it will be understood that it is not intended to limit the invention to such embodiments.

### DETAILED DESCRIPTION OF THE INVENTION

Quantum computers function in a fundamentally different way compared to classical computing devices. By leveraging quantum phenomena, such as superposition and entanglement, quantum computers show potential for increased computational power unrivaled by their classical counterparts. Hence, quantum computers are uniquely positioned to tackle certain scientific problems that, although they could be solved by classical methods, the excessive computational time or memory requirements associated with such classical methods render them insufficient for many purposes. Examples of scientific problems that are more suited for quantum computers include, but are not limited to, modelling molecules, material science, and cryptanalysis.

Density functional theory (DFT) is a quantum mechanical atomistic simulation method that can be used to compute the electronic structure of atoms, molecules, and solids. Using DFT, the properties of a many-electron system, such as structurally large or even strongly correlated physical systems, can be determined using functionals. The term “functional” is understood in the art to refer to a mathematical construct of a function of a function. The term “strongly correlated” refers to the behaviour of electrons in materials that are not well described by simple one-electron theories such as the local-density approximation (LDA) of density functional theory or Hartree-Fock theory. Specifically, examples of strongly correlated materials have incomplete d- or f-electron shells with narrow energy bands such that one cannot consider any single electron in the material as being in a “sea” of the averaged motion of the other electrons as described in the mean field theory. Each individual electron in a strongly correlated material has a complex influence on its neighbouring electrons. Thus, strongly correlated materials have electronic structures that are neither simply free-electron-like nor completely ionic, but a mixture of both. It is at least in part the complex electron interaction that makes it extremely difficult for a classical computer to accurately model the behaviour of large and strongly correlated materials.

The DFT functional determination methods and systems described in examples herein may be applied to investigate the electronic structure (principally the ground state) of many-body systems, particularly in scenarios where systems to be investigated include atoms, molecules, and condensed phases that are structurally large and strongly correlated, whose classical simulation becomes intractable due to immense computational resource and time demands. In one aspect, the DFT functional determination method and system described herein is a hybrid approach where the method/system is to be executed in part on a classical computing device and in part on a quantum processing device. The disclosed methods and systems utilize a quantum computer to simulate physical systems and generate electronic density and energy data pairs of relatively high degrees of accuracy and quality to enable the training of a DFT functional determination neural network to determine parameters of a corresponding DFT functional.

In at least one aspect, the disclosed methods and systems provide the technical effect of improved DFT functional determination by using a machine-learning-based technique trained using data generated using quantum computers, where the training data is of a high degree of accuracy and quality without requiring excessive use of computational resources.

In another aspect, the methods and systems described herein provide a further technical effect of a flexible DFT functional determination that can be applied to a wide range of molecules and materials of interest. Specifically, a neural network may be trained with training data generated from, at least in part, a quantum computer such that it may be adopted for physical systems of interest.

All information pertaining to a quantum mechanical system, or physical system as referred to herein, can be described by a wave function ψ(r₁, r₂, . . . , r_{N}), where r is the position vector (x, y, z) of each of the N electrons in the system. Wavefunctions can be obtained by solving a mathematical relationship known as the Schrodinger equation. The time-independent form of the Schrödinger equation used to describe stationary multi-body systems may be written as:

Ĥ|« [symbol] =E|ψ [symbol] , Equation (1)

where Ĥ is the Hamiltonian operator and E is the total energy of the system. With the Born-Oppenheimer approximation, according to which nuclei of atoms are seen as fixed relative to fast-moving electrons, energy terms such as the nuclei kinetic energy and the internuclear repulsive energy can be omitted. Hence, the total energy term in Equation (1) may be expressed in the form:

E=T+Eₛ+E_{XC}, Equation (2)

where T and Eₛ are the kinetic and electrostatic energies, respectively, of a fictitious non-interacting system, and E_{XC} is the exchange-correlation energy. E_{XC} accounts for the correlated motion of electrons with one another due to their spin. Generally, E_{XC} is the energy term that is the most challenging to compute.

The electronic structure problem defined in Equation (2) can be recast in terms of the electronic density n(r). The Hohenberg-Kohn theorem proves that a universal functional for the total energy E of an atom, molecule, or ion can be defined in terms of the electronic density n(r), and also shows that the total energy and other observable properties are functionals of n(r) (e.g., E[n](r)).

Even with the Born-Oppenheimer approximation, the resulting computations required to solve Equation (2) remain a huge computational undertaking that becomes computationally intractable when dealing with large multi-body systems. Here, DFT becomes a useful method to deal with the modelling complexity. By expressing the system energies, as shown in Equation (2), as functionals of the electronic density, the resulting mathematical model is simpler to simulate compared to the full wavefunction-based methods. This permits the formulation of equations for computing energies of systems that are less computationally challenging to solve than the Schrodinger equation, but generally require the use of approximations. For example, by adopting the Kohn-Sham equations, the resulting Kohn-Sham DFT may be conceptualized as replacing the system of mutually interacting electrons, which is impossible to solve analytically, by a problem of independent electrons described by ϕᵢ(r) evolving in an external potential:

[−1/2∇ᵢ²+uₛ(r)]ϕᵢ(r)=εᵢϕᵢ(r),

where uₛ(r) is the effective potential, εᵢ is the energy of the Kohn-Sham orbital ϕᵢ(r), and the electronic density n(r) for η electrons can be computed as:

$$n ( r ) = {\sum }_{i = 1}^{η} {‖ {ϕ}_{i} ( r ) ‖}^{2} . \qquad Equation ( 3 )$$

With the Kohn-Sham equations, the total energy may be derived from the associated eigenvalues as the sum of energies of the individual independent particles. The effective potential uₛ(r) is to be determined in order to solve Equation (2).

The exchange-correlation energy per electron for a fixed electronic density n(r) may be denoted as a functional E_{XC}[n](r). It follows that the total exchange-correlation energy E_{XC} may be generally expressed as an integral of E_{XC}[n](r):

E_{XC}=∫E_{XC}[n](r)d³r. Equation (4)

E_{XC}[n](r) is also referred to as the exchange-correlation functional. General exchange-correlation functionals can be expressed as a combination of other functionals in a given set. This is referred to as a hybrid functional construction, which may be done by any suitable method, including the internal method and the external method. For example, by adopting the internal method, Equation (4) is rewritten in the form of an integral for a linear combination of functionals:

$${E}_{XC} = \int {\sum }_{i = 1}^{N} {c}_{i} {E}^{( i )} [ n ] ( r ) {d}^{3} r , \qquad Equation ( 5 )$$

where cᵢ is a coefficient representative of the contribution from the i-th electron. Alternatively, using the external method, Equation (4) is rewritten as a linear combination of energy integrals:

$${E}_{XC} = {\sum }_{i = 1}^{N} {c}_{i} \int {E}^{( i )} [ n ] ( r ) {d}^{3} r = {\sum }_{i = 1}^{N} {c}_{i} {E}^{( i )} . \qquad Equation ( 6 )$$

The coefficients cᵢ parameterize the exchange-correlation functional expressed in Equation (5) or (6). In one aspect, the aim is to determine as accurate of an estimate of the coefficients cᵢ as possible so that the DFT functional is of sufficient accuracy to make predictions for a given physical system of interest.

For conciseness and clarity, the present disclosure describes the internal method of hybrid functional construction. It is to be understood that other methods, such as the external method, may also be adopted on a mutatis mutandis basis.

Thus, in one aspect, the present disclosure provides a trained neural network that is configured to receive an input in the form of, for example, electronic density n(r) or any other features from which the ground-state energy of a system may be determined, such as gradients of the density, and generate the coefficient vector \vec{c}[n](r)=(c₁[n](r), c₂[n](r), . . . , c_{N}[n](r)) for parameterizing the DFT functional such that the exchange-correlation energy E_{XC} as expressed in Equations (5) or (6), and hence the total energy E in Equation (2), may be determined.

The accuracy of the trained neural network in the DFT module 120 will be limited by the quality of the training data, and specifically training data pertaining to structurally large and strongly correlated systems. In one aspect, the present disclosure leverages quantum computers to generate classical data, which can be used as training data, having relatively high degrees of accuracy and quality to ensure that the resulting trained neural network can more accurately parameterize the DFT functional.

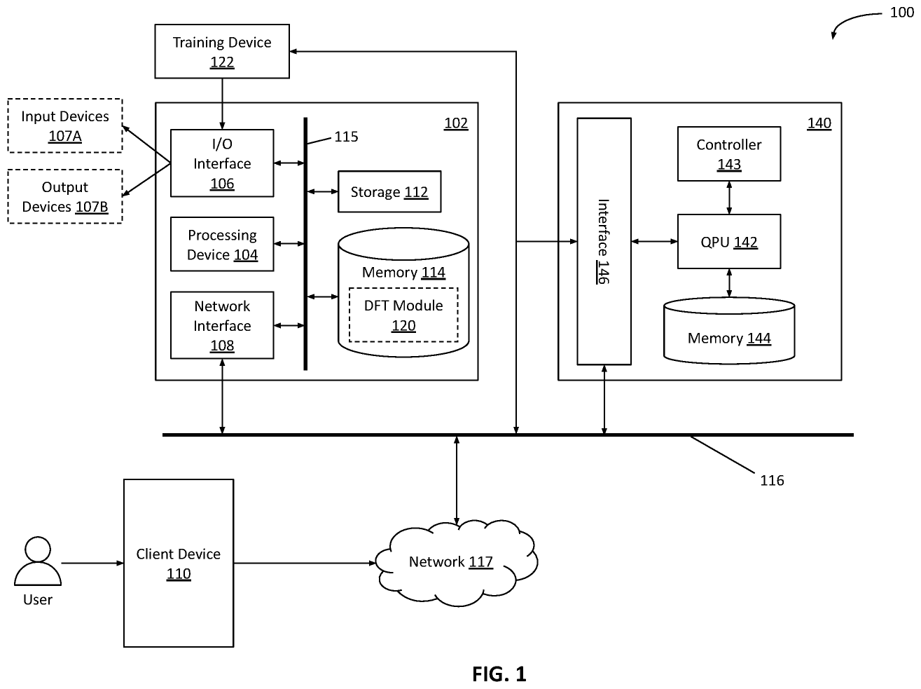

Reference is made to FIG. 1, which shows a simplified block diagram of an example embodiment of the present disclosure as a system 100. The following description shall not be construed as a limitation to any examples of this disclosure.

The system 100 includes a classical processing module 102, which is configured to execute the instructions of a trained neural network to perform DFT functional determination in accordance with examples disclosed herein. The classical processing module 102 may also be tasked with performing part of the DFT functional determination, including determining an electronic density function as described in more detail below. In some embodiments, the classical processing module 102 is, for example, a desktop terminal, a tablet computer, a notebook computer, a server, a cloud backend, or any suitable processing system. Other classical computing systems suitable for implementing embodiments described in the present disclosure may be used, which may include components different from those discussed below. In some examples, the classical processing module 102 may be implemented across more than one physical hardware unit, such as in a parallel computing, distributed computing, virtual server, or cloud computing configuration. Although FIG. 1 shows a single instance of each component of the classical processing module 102, there may be multiple instances of each component shown.

The classical processing module 102 may include one or more classical processing devices 104, such as central processing unit (CPU) with hardware accelerator, graphics processing unit (GPU), tensor processing unit (TPU), neural processing unit (NPU), a microprocessor, digital signal processor, an application-specific integrated circuit (ASIC), a field-programmable gate array (FPGA), a dedicated logic circuitry, a dedicated artificial intelligence processor unit, or combinations thereof.

The classical processing unit 102 may also include one or more input/output (I/O) interfaces 106, which may enable interfacing with one or more optional input devices 107A and/or optional output devices 107B. In the example shown, the input devices 107A (e.g., a keyboard, a mouse, a touchscreen, and/or a keypad) and output devices 107E3 (e.g., a display, a speaker, and/or printer) are shown as optional and external to the classical processing module 102. In other examples, one or more of the input devices 107A and/or the output devices 107B may be included as a component of the classical processing module 102. In other examples, there may not be any input devices 107A and output devices 107B, in which case the I/O interface 106 may not be needed.

The classical processing module 102 may include one or more optional network interfaces 108 for wired or wireless communication with a network 116 (e.g., an intranet, the Internet, a peer-to-peer (P2P) network, a Wide Area Network (WAN), and/or a Local Area Network (LAN)) to operably communicate with one or more client devices 110. The network interfaces 108 may include wired links (e.g., Ethernet cable) and/or wireless links (e.g., one or more antennas) for intra-network and/or inter-network communication. One or more end users may interact with the system 100, for example, inputting training data and/or system parameters describing a physical system for which a DFT functional evaluation is required to the classical processing module 102 through one or more of the input device 107A and/or client devices 110. The results generated by the classical processing module 102 may be presented to the user through one or more of the output devices 10713.

The client device 110 may be a classical processing module similar to the classical processing module 102. The client device 110 may be connected to a network 117 (e.g., an intranet, the Internet, a P2P network, a WAN, and/or a LAN), which is operably connected to network 116. Although networks 116 and 117 are shown as separate networks, it is understood that this is not intended to be limiting. In some embodiments, networks 116 and 117 may refer to the same network.

The classical processing module 102 may also include one or more storage units 112, which may include a mass storage unit such as a solid-state drive, a hard disk drive, a magnetic disk drive, and/or an optical disk drive. The classical processing module 102 may include one or more memories 114, which may include a volatile or non-volatile memory (e.g., a flash memory, a random-access memory (RAM), and/or a read-only memory (ROM)). The non-transitory memory of memory 112 may store instructions for execution by the processing device(s) 104, such as to carry out examples described in the present disclosure, for example DFT functional determination instructions and data for neural network processor 200 to carry out the machine learning aspect of the present disclosure. The memory(ies) 114 may include other software instructions, such as for implementing an operating system for the classical processing module 102 and other applications/functions. In some examples, one or more data sets and/or modules may be provided by an external memory (e.g., an external drive in wired or wireless communication with the classical processing module 102) or may be provided by a transitory or non-transitory computer-readable medium. Examples of non-transitory computer-readable media include a RAM, a ROM, an erasable programmable ROM (EPROM), an electrically erasable programmable ROM (EEPROM), a flash memory, a CD-ROM, or other portable memory storage. In some examples, the non-transitory memory of memory 114 may store machine-readable software instructions that are executable by the processing device 104 to train and/or implement a DFT module 120 as disclosed herein.

In some embodiments, there may be a bus 115 providing communication among components of the classical processing module 102, including the processing device 104, optional I/O interface 106, network interface 108, storage 112, and memory(ies) 114. The bus 115 may be any suitable bus architecture including, for example, a memory bus, a peripheral bus, or a video bus.

As will be discussed further below, in some embodiments, the DFT module 120 is a trained neural network. The training of the DFT module 120 may be performed by a training device 122, using training data generated at least in part from a quantum processing module 140. The trained DFT module 120 may be used to implement a method of determining a DFT functional for a given physical system, according to examples disclosed herein. The training device 122 may use samples of the training data generated by the quantum processing module 140 to train the DFT module 120. The training data may further include any pertinent empirical data obtained from experiment or those retrieved from memory or external database. Although FIG. 1 illustrates an example in which the training device 122 is separate from the classical processing module 102, it should be understood that the present disclosure is not limited to this embodiment. In some examples, there may not be a separate training device 122 and classical processing module 102. That is, training of the DFT module 120 and implementation of the trained DFT module 120 may be at the same device.

The quantum processing module 140 is configured to generate classical data which may be used as training data. In some embodiments, the training data may include a data pair that includes an electronic density function and a corresponding energy value. The energy value may be, for example, the exchange-correlation energy of the corresponding physical system. In further embodiments, training data may include any data suitable for training a neural network for the purpose of generating DFT functionals, including classical shadows and reduced density matrices among others.

In the embodiment shown, the quantum processing module 140 includes a quantum processing unit (QPU) 142 operably coupled to a memory 144 and an interface 146. As shown in FIG. 1, the memory 144 may store one or more of: representations of quantum systems, representations of quantum gates, representations of one or more variational quantum circuits, and particle-conserving unitaries. Alternatively, or in addition, the memory 144 may store instructions, for example to cause the QPU 142 to execute one or more quantum applications and/or instructions as described herein.

The optional interface 146 is configured for wired or wireless communication with a network 116, and thus operably connected to the classical processing module 102. The interface 146 may be implemented in software (e.g., a graphical user interface (GUI) for receiving input to a quantum simulation and/or for displaying simulation results). In other embodiments, the interface 146 may also include hardware configured for transferring classical data to quantum data and vice versa. The interface 146 hardware may include semiconductor circuits, superconductor circuits, optical devices and channels, digital circuits, and analog circuits. For embodiments where one or more hardware for input conversion operates at a low temperature (i.e., −273 degrees Celsius), the interface may include additional cooling components.

The quantum processing module 140 may be based on a suitable form of physical qubit, including superconducting qubits, photonic qubits, trapped-ion qubits, silicon-based qubits, and neutral atoms. The QPU 142 manipulates one of the physical properties of the input state by performing quantum operations such as applying unitary transformations. The QPU includes one or more measurement components (e.g., photon number resolving detectors) configured to measure the output of the QPU 142 and provides simulation results from a quantum simulation process. The quantum processing module 140 is configured to communicate, via network 116, with one or more remote computing devices, such as client device 110, classical processing module 102, and/or training device 122, for example. The quantum processing module 140 receives input to a quantum simulation process from client device 110 and outputs simulation results to the training device 122 as classical data. The quantum processing module 140 may also be referred to as the “quantum data factory” within the present disclosure.

The training data may be stored within a non-transitory storage or memory (not shown) within the training device 122. Alternatively, if the training device 122 is a module within classical processing module 102, then the training data may be stored in storage 112 or memory 114. The training data may include experimental data obtained from experimental or physical measurement in addition to classical data generated from the quantum processing module 140. In some embodiments, the training data includes data pairs where each pair comprises an electronic density function n(r) and a corresponding energy value. The energy value may be, for example, the exchange-correlation energy of the physical system in question.

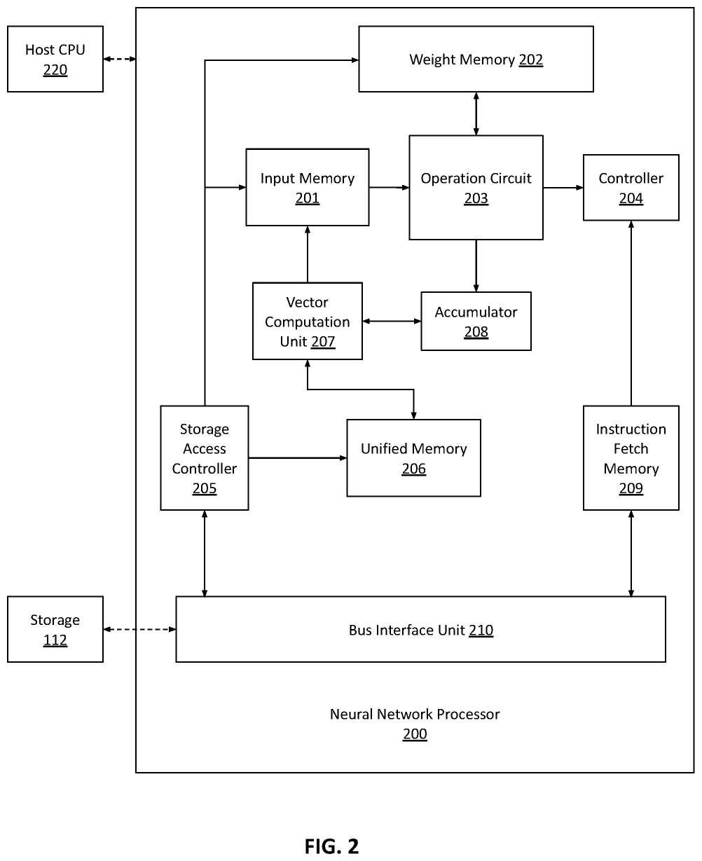

FIG. 2 is a block diagram illustrating an example hardware structure of an example neural network processor 200 according to an embodiment of the present disclosure. The neural network processor 200 may be provided on an integrated circuit. The neural network processor 200 may be provided in the classical processing module 102 shown in FIG. 1, to perform computation for and/or to implement the DFT module 120. Additionally or alternatively, the neural network processor 200 may be provided in the training device 122 shown in FIG. 1 to perform training of the DFT module 120. All the algorithms of the layers of a neural network (e.g., the neural network in the DFT module 120 as discussed further below) may be implemented in the neural network processor 200.

The neural network processor 200 may be any processor that is capable of performing the computations required in a neural network (e.g., to compute massive exclusive OR operations). For example, the neural network processor 200 may be a neural processing unit (NPU), a tensor processing unit (TPU), a graphics processing unit (GPU), or the like. The neural network processor 200 may be a co-processor to an optional host central processing unit (CPU) 220. For example, the neural network processor 200 and the host CPU 220 may be mounted on the same package. The host CPU 220 may be responsible for performing core functions of an execution device (e.g., execution of an operating system (OS), managing communications, etc.). The host CPU 220 may manage operations of the neural network processor 200, for example by allocating a task to the neural network processor 200.

The neural network processor 200 includes an operation circuit 203. A controller 204 of the neural network processor 200 controls the operation circuit 203 to, for example, extract data (e.g., matrix data) from an input memory 201 and a weight memory 202 of the neural network processor 200, and perform data operations (e.g., addition and multiplication operations).

In some examples, the operation circuit 203 internally includes a plurality of processing units (also referred to as process engines (PEs)). In some examples, the operation circuit 203 is a bi-dimensional systolic array. In other examples, the operation circuit 203 may be a uni-dimensional systolic array or another electronic circuit that can implement a mathematical operation such as multiplication and addition. In some examples, the operation circuit 203 is a general matrix processor.

In an example operation, the operation circuit 203 obtains, from the weight memory 202, weight data of a weight matrix B, and caches the weight data in each PE in the operation circuit 203. The operation circuit 203 obtains, from the input memory 201, input data of an input matrix A and performs a matrix operation based on the input data of the matrix A and the weight data of the matrix B. An obtained partial or final matrix result is stored in an accumulator 208 of the neural network processor 200.

In this example, the neural network processor 200 includes a vector computation unit 207. The vector computation unit 207 includes a plurality of operation processing units. If needed, the vector computation unit 207 performs further processing (e.g., vector multiplication, vector addition, an exponent operation, a logarithm operation, or magnitude comparison), on an output from the operation circuit 203 (which may be retrieved by the vector computation unit 207 from the accumulator 208). The vector computation unit 207 may be mainly used for computation at a non-convolutional layer or fully-connected layer of a neural network. For example, the vector computation unit 207 may perform processing or computation such as pooling or normalization. The vector computation unit 207 may apply a nonlinear function to an output of the operation circuit 203, for example, a vector of an accumulated value, to generate an activation value which may be used by the operation circuit 203 as activation input for a next layer of a neural network. In some examples, the vector computation unit 207 generates a normalized value, a combined value, or both a normalized value and a combined value.

The neural network processor 200 in this example includes a storage unit access controller 205 (also referred to as a direct memory access control (DMAC)). The storage unit access controller 205 is configured to access a memory external to the neural network processor 200 (e.g., the storage 112 of the classical processing module 102) via a bus interface unit 210. The storage unit access controller 205 may access data from the memory external to the neural network processor 200 and transfer the data directly to one or more memories of the neural network processor 200. For example, the storage access unit controller 205 may directly transfer weight data to the weight memory 202, and may directly transfer the input data to a unified memory 206 and/or the input memory 201. The unified memory 206 is configured to store input data and output data (e.g., a processed vector from the vector computation unit 207).

The bus interface unit 210 is also used for interaction between the storage access unit controller 205 and an instruction fetch memory (also referred to as an instruction fetch buffer) 209. The bus interface unit 210 is further configured to enable the instruction fetch memory 209 to obtain an instruction from a memory external to the neural network processor 200 (e.g., the storage 112 or memory 114 of the classical processing module 102). The instruction fetch memory 209 is configured to store the instruction for use by the controller 204.

Generally, the unified memory 206, the input memory 201, the weight memory 202, and the instruction fetch memory 209 are all memories of the neural network processor 200 (also referred to as on-chip memories). The storage 112 is independent from the hardware architecture of the neural network processor 200.

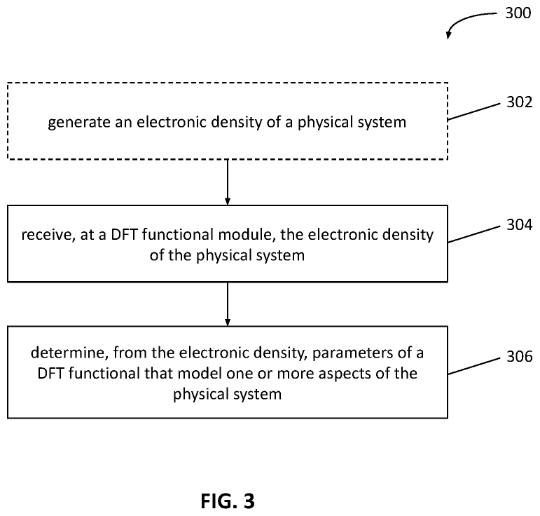

FIG. 3 illustrates a flowchart of an example method 300 that may be executed by system 100 in accordance with the present disclosure.

At 302, system 100 may optionally be configured to generate an electronic density function (also referred to as an electronic density herein) for a given physical system. In such embodiments, the electronic density may be generated based on user input received from client device 110, or from data stored in memory 114. In some embodiments where a high degree of accuracy is required, the electronic density may be generated using the quantum processing module 140. In some further embodiments where the tolerance or margin of error in the electronic density may be greater than that of the corresponding exchange-correlation energy, the electronic density generation may be performed by a classical computing system, such as classical processing module 102.

At 304, the electronic density is received by a density functional theory (DFT) functional module. In embodiments where the electronic density is generated by the system 100, the electronic density may be retrieved from storage 112 or memory 114. In other embodiments where the electronic density is not generated by the system 100, the electronic density may be received as user input from client device 110.

At 306, the electronic density is provided as an input to the DFT functional module, which in turn determines parameters of a DFT functional that model one or more aspects (e.g., the exchange-correlation energy or the ground-state energy) of the physical system. The DFT functional module, a machine learning module, is trained using training data generated at least in part from the quantum processing module 140, and deployed onto a classical processing device. The synergistic combination of classical and quantum processing modules permits the training of a machine learning model that may accurately model one or more physical systems given the high quality training data generated by leveraging quantum computing as described in more detail herein.

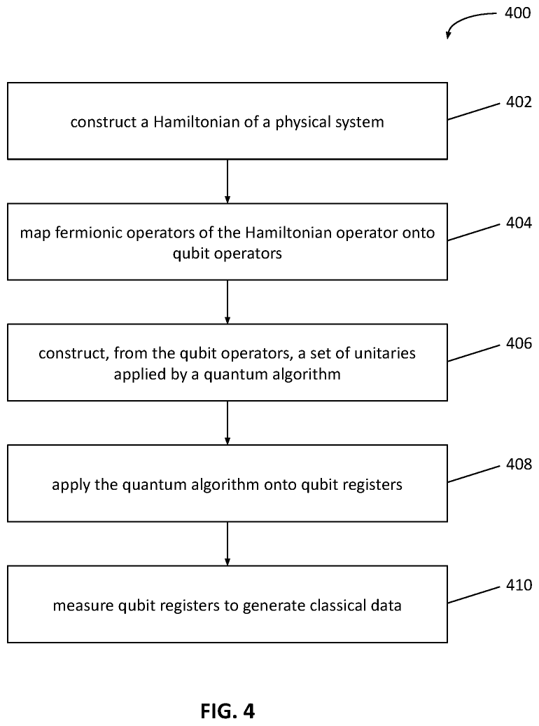

FIG. 4 illustrates a flowchart of an example method 400 for generating training data in accordance with some embodiments of the present disclosure. Method 400 may be, at least in part, performed by the quantum processing module 140, also referred to as a quantum data factory, as shown in FIG. 1, for example.

A system of interacting electrons in the presence of Coulomb potential generated by charged nuclei fixed at specific coordinates, which can be used to describe molecules and materials, can be specified by a Hamiltonian operator. Thus, at 402, a Hamiltonian describing the system energy is constructed. The Hamiltonian may be constructed following the second quantization formalism as:

$$H = {\sum }_{pq} {h}_{pq} {c}_{p}^{†} {c}_{q} + \frac{1}{2} {\sum }_{pqrs} {h}_{pqrs} {c}_{p}^{†} {c}_{q}^{†} {c}_{r} {c}_{s} , \qquad Equation ( 7 )$$

where c^{†} and c are the fermionic creation and annihilation operators, and

$${h}_{pq} = \int {ϕ}_{q}^{*} ( r ) ( - \frac{{∇}^{2}}{2} - {\sum }_{I} \frac{{Z}_{I}}{\vert r - {R}_{I} \vert} ) {ϕ}_{p}^{*} ( r ) dr , \qquad Equation ( 8 )$$

$${h}_{pqrs} = \int \frac{{ϕ}_{p}^{*} ( {r}_{1} ) {ϕ}_{q}^{*} ( {r}_{2} ) {ϕ}_{r} ( {r}_{2} ) {ϕ}_{s} ( {r}_{1} )}{\vert {r}_{1} - {r}_{2} \vert} {dr}_{1} {dr}_{2} , \qquad Equation ( 9 )$$

where Equations (8) and (9) are the one- and two-electron integrals yielded from a set of orbitals ϕₚ(r), respectively.

Alternatively, the Hamiltonian may be constructed following the first quantization formalism as:

$$H = {\sum }_{pq} {h}_{pq} \vert p 〉 〈 q \vert + \frac{1}{2} {\sum }_{pqrs} {h}_{pqrs} \vert p 〉 〈 q \vert \vert r 〉 〈 s \vert . \qquad Equation ( 10 )$$

At 404, the fermionic operators of the Hamiltonian in either Equations (7) or (10) are mapped to qubit operators. The mapping may be performed by any one of the many possible fermionic-to-qubit mappings known in the art. By way of a non-limiting example, when the second quantization approach is adopted, the Jordan-Wigner transformation may be used. According to the Jordan-Wigner transformation, a state |n₁, n₂, . . . , n_{M} [symbol] in the occupation number representation on M spin-orbitals can be directly mapped to a state |n₁ [symbol] |n₂ . . . |n_{M} [symbol] on M qubits, where the state of the i-th qubit is |1 [symbol] if the corresponding spin-orbital is occupied, and |0 [symbol] otherwise. Fermionic ladder operators may be transformed as:

cₚ=1/2Z₀⊗ . . . Zₚ₋₁⊗(Xₚ+iYₚ) Equation (11)

cₚ⁵⁵⁴=1/2Z₀⊗ . . . Zₚ₋₁⊗(Xₚ+iYₚ) Equation (12)

where X, Y,Z are Pauli operators. The conversion results in a Hamiltonian of the form:

$$H = {\sum }_{j} {h}_{j} {P}_{j} ,$$

where Pⱼ is a tensor product of the Pauli matrices I, X, Y, Z.

Alternatively, for Hamiltonians constructed with the first quantization formalism at 402 in accordance with Equation (10), a general state is written as a sum of weighted Slater determinants of η electrons in N orbitals:

$$\vert ψ 〉 = {\sum }_{i ∈ ( \frac{N}{η} )} {c}_{i} 𝒜 ( \vert {p}_{{i}_{1}} , … , {p}_{{i}_{η}} 〉 ) , \qquad Equation ( 13 )$$

where Σᵢ|cᵢ|²=1 with the index i denoting a choice of η occupied orbitals, and

$$𝒜 : \vert {p}_{{i}_{1}} , … , {p}_{{i}_{η}} 〉 \to {\sum }_{σ ∈ {s}_{η}} \frac{{( - 1 )}^{π ( σ )}}{\sqrt{η !}} \vert σ ( {p}_{{i}_{1}} , … , {p}_{{i}_{η}} ) 〉 , \qquad Equation ( 14 )$$

where [symbol] is the anti-symmetrization operator, S_{η} is the symmetric group on η elements, π(σ) is the parity of the permutation, and |pᵢ_{₁}, . . . , p|pᵢ_{_{η}} [symbol] =||pᵢ_{₁} [symbol] ||pᵢ_{₂} [symbol] . . . |p|pᵢ_{_{η}} [symbol] is an ordered product state of η registers with n qubits each.

At 406, a set of unitaries is constructed from the qubit operators, wherein the unitaries are to be applied by a quantum algorithm. The quantum algorithm may be any suitable algorithm, including but not limited to, variational quantum eigensolver, adiabatic quantum algorithms, Krylov subspace methods, imaginary-time evolution, and quantum phase estimation.

In an exemplary embodiment which implements quantum phase estimation as the quantum algorithm, an approximate starting state |ψ [symbol] may be obtained from an approximate classical or quantum algorithm in accordance with Equation (13). A unitary operator U is constructed such that it is diagonal in the same basis as the input Hamiltonian constructed at step 404. The ground state of the Hamiltonian is also an eigenstate of U with the eigenvalue e^{i2πϕ}^{₀}. The ground-state energy E₀ becomes a function of ϕ₀, meaning that the ground-state energy can be derived from computing the phase ϕ₀.

At 408, the quantum algorithm is applied onto qubit registers. Specifically, a system of t auxiliary qubits in an equal superposition state is prepared. The unitary operator U constructed at 406 is then applied to the input state controlled on the state of the first auxiliary qubit, U² is applied controlled on the second auxiliary qubit, and so forth until U²^{^{t}} is applied controlled on qubit t.

The unitary operator U applies a unitary transformation to the qubits used to represent the state of the system. This transformation may be realized through various hardware and/or software components of QPU 142. By way of a non-limiting example, in the case of continuous variable (CV) photonic platforms, quantum photonic gates forming a universal gate set may be used. In some embodiments, a universal gate set includes two-mode beamsplitters along with single-mode gates including squeezers, displacers, phase gates, and non-linear gates. Often, beamsplitters and phase shifters can be combined to create an N-mode linear-optical interferometer. Any appropriate combination of interferometers, squeezers, displacers, and phase shifters can perform a so-called Gaussian transformation, and such components are often referred to as Gaussian units. The combination of Gaussian units and non-Gaussian gates can be used for universal CV quantum computation, such as any unitary generated by a Hamiltonian which can be constructed by building up from these elementary gates using a polynomial-depth circuit.

The single-mode elementary gates, including squeezers, displacers, and phase shifters, and two-mode beamsplitters may have a number of controllable parameters which can be used to alter the unitary transformation performed by the QPU 142. The parameters may include, for example, squeezing factor of the squeezers, amount of displacement applied by the displacers, phase shift introduced by the phase shifters, and splitting ratio of the beamsplitters. The configuration of these parameters is also referred to as the setting of the QPU 142, which may be manipulated and/or controlled by a controller 143 either with pre-determined or dynamically generated settings.

At 410, after applying an inverse quantum Fourier transform on the auxiliary qubits, the auxiliary qubits are measured in the computational basis, which leads to an output state of:

|bin(ϕₖ) [symbol] |ψₖ [symbol] ,

where |bin(ϕₖ) [symbol] is a binary representation of ϕₖε[0,1]. In particular with probability p₀=| [symbol] ψ₀|ψ [symbol] |², the output is the state:

|bin(ϕ₀) [symbol] |ψ₀ [symbol] .

This permits the phase ϕ₀, and hence the ground-state energy E₀, to be estimated in the form of classical data. The ground-state energy E₀ can subsequently be used to determine the exchange-correlation energy E_{XC} of the system. The electronic density n(r) and its correspondingly determined energy value (e.g., E₀or E_{XC}) form one data pair of the training data that is to be used to train the DFT module 120. In some further embodiments, as the tolerance for errors in the electronic density n(r) may be greater than that of the exchange-correlation energy, the electronic density determination may be performed by a classical computing system, such as classical processing module 102. In some embodiments, the electronic density may be determined by the classical processing module 102 for example by using the Kohn-Sham approach based on Equation (3) by solving for the wavefunction (Slater determinant) of the non-interacting electrons (i.e., by finding the molecular orbitals) and then building the density from the molecular orbitals.

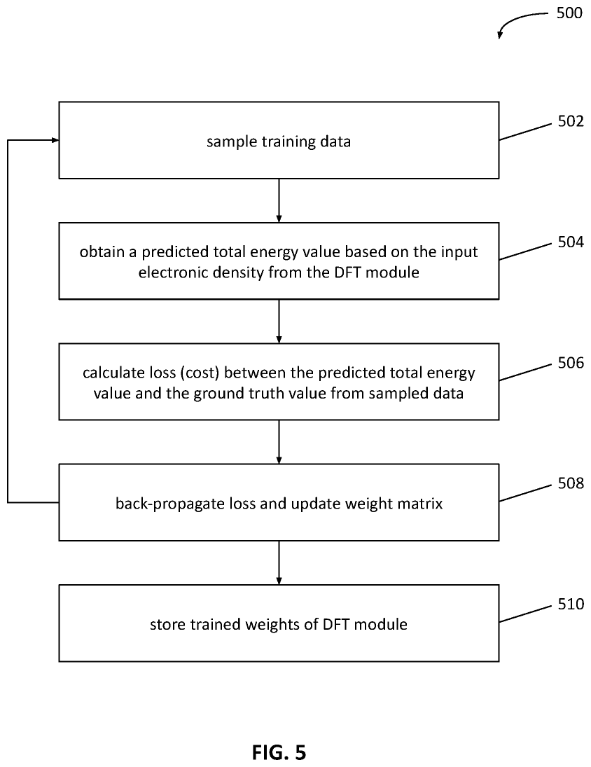

FIG. 5 illustrates a flowchart of an example method 500 for training the DFT module 120 in accordance with some embodiments of the present disclosure. Method 500 may be performed by a neural network processor 200 in the training device 122 shown in FIG. 1, for example.

The DFT module 120 is a neural network, which includes a network of interconnected nodes. A node is a computational unit that takes a value xₛ as input. An output from the computational unit may be:

$${h}_{W , b} ( x ) = f ( {\sum }_{s = 1}^{n} {W}_{s} {x}_{s} + b ) ,$$

where s=1,2, . . . , n, n is a natural number greater than 1, Wₛ is a weight of xₛ, b is an offset (i.e., bias) of the node, and f is an activation function of the node and used to introduce a nonlinear feature to the neural network. The output of the activation function may be used as an input to a node of a following layer in the neural network. The activation function may be a sigmoid function, for example. The neural network is formed by joining a plurality of the foregoing single nodes. In other words, an output from one node may be an input to another node. An input of each node may be associated with a local receiving area of a previous layer to extract a feature of the local receiving area. The local receiving area may be an area consisting of several nodes.

In some embodiments, the DFT module 120 may be a deep neural network (DNN), also referred to as a multi-layer neural network, and may be understood as a neural network that includes a first layer (generally referred to as an input layer), a plurality of hidden layers, and a final layer (generally referred to as an output layer). The “plurality” herein does not have a special metric. A layer is considered to be a fully connected layer when there is a full connection between two adjacent layers of the neural network. To be specific, for two adjacent layers (e.g., the i-th layer and the (i+1)-th layer to be fully connected, each and every node in the i-th layer must be connected to each and every node in the (i+1)-th layer. The DNN may be of any suitable structural form, such as a multi-layer perceptron (MLP).

Generally in a DNN, a greater number of hidden layers may enable the DNN to better model a complex situation (e.g., DFT functional determination). In theory, a DNN with more parameters is more complex, has a larger capacity (which may refer to the ability of a learned model to fit a variety of possible scenarios), and indicates that the DNN can complete a more complex learning task. Training of the DNN is a process of learning the weight matrix. A purpose of the training is to obtain a trained weight matrix, which consists of the learned weights W of all layers of the DNN.

The method 500 may begin with an initialization step (not shown in FIG. 5). Initialization may be performed to initialize temporary buffers, for example, which can be used to store values used in the training, such as computed loss. Initialization may also be performed to initialize the weights of the DFT module 120. The DFT module 120 may be trained for a defined number of iterations (e.g., thousands of iterations). Alternatively, the DFT module 120 may be iteratively trained until a desired output (e.g., one that is within a specified error tolerance) is achieved. Each training iteration for the DFT module 120 may be performed using steps 502 to 508, for example.

At 502, training data pairs are sampled from training data. In this case, the training data comprises data pairs {n*ⱼ(r), E*ⱼ} (an electronic density and a corresponding energy value, respectively) at least partially generated by a quantum processing module 140 by implementing the method 400. In some embodiments, the training data may also be supplemented with empirical data obtained from measurements of other physical systems of interest. In some further embodiments, one or more electronic density may be determined using a classical computing system, such as classical processing module 102. A single data pair may be sampled randomly or sequentially. Alternatively, in the case where batch training is to be performed, the input may include multiple data pairs of electronic density and corresponding energy value randomly or sequentially sampled from the training data.

At 504, the electronic density from the sampled training data is provided as input to the DFT module 120, and a predicted energy value is obtained as output from the DFT module 120. In the case of batch training, a set of energy values may be generated for respective electronic densities n(r) in the sampled batch.

Recall that the exchange-correlation energy E_{XC} may be expressed in terms of Equation (4) based on the external method of hybrid functional construction, or Equation (5) based on the internal method of hybrid functional construction. By way of a non-limiting example, when Equation (4) is used, the coefficients in \vec{c}[n](r)=(c₁[n](r) , c₂[n](r) , . . . , c_{N}[n](r)) are themselves functionals of the electronic density, which is fundamentally different from hybrid functionals where these coefficients are fixed as is typically done for hybrid functional construction (i.e., the Becke-3-parameter-Lee-Yang-Parr (B3LYP) exchange-correlation functional).

The notation f_{θ}[n] is used to denote the mapping f_{θ}[n]: n(r)→c[n](r) that is to be performed by the neural network of DFT module 120. Here, θ represents the parameters of the neural network that will be trained from sampled data (i.e., the weights W).

The output of the entire model can be expressed by the relationship E_{XC}[n](θ)=∫f_{θ}[n](r)·\vec{E}[n](r)d³r, where \vec{E}[n](r)=(E₁[n](r), E₂[n](r), . . . , E_{N}[n](r)). The output of the model is the value E_{XC}[n](θ) that represents a predicted value of the exchange-correlation energy of the system.

Because there may be a large number of layers in the DNN of DFT module 120, there may also be a large number of weights W (or elements in θ) and offset vectors \vec{b}. Generally, a weight from a k-th node at an (L−1)-th layer to a j-th node at an L-th layer may be denoted as Wⱼₖ^{L}. It should be noted that there is no W parameter in the input layer.

At 506, the predicted value outputted by the DNN may be compared to a ground truth value (e.g., the energy value within the same data pair as the electronic density). A weight vector (which is a vector containing the weights W for a given layer) of each layer of the DNN is updated based on a difference between the predicted value and the desired target value. For example, if the predicted value output by the DNN is excessively high, the weight vector for each layer may be adjusted to lower the predicted value. This comparison and adjustment may be carried out iteratively until a convergence condition is met (e.g., a predefined maximum number of iterations has been performed, or the predicted value output by the DNN is sufficiently close to the desired target value). A loss function or an objective function is defined as a way to quantitatively represent how close the predicted value is to the target value. An objective function represents a quantity to be optimized (e.g., minimized or maximized) in order to bring the predicted value as close to the target value as possible. A loss function more specifically represents the difference between the predicted value and the target value, and the goal of training the DNN is to minimize the loss function (also referred to as a cost function). In this example, the cost function may be defined as:

$$C ( θ ) = \frac{1}{M} {\sum }_{j = 1}^{M} D ( {E}_{j}^{*} - {E}_{j} ( θ ) + β R ( θ ) ) , \qquad Equation ( 15 )$$

where D is a distance function, E*ⱼ is the ground truth energy from the sampled training data, Eⱼ(θ) is the predicted energy value from the DFT module 120, R is a regularization function (or weight decay function), and β is a regularization parameter. The regularization term is to prevent or to ameliorate overfitting by the model in trying to capture noise in the training data. Regularization introduces an additional penalty term in the cost function thereby preventing weights from taking on extreme values.

At 508, the cost C(θ) is back-propagated to adjust (also referred as update) values of one or more parameters (e.g., weights) in the DNN, so that the error (or loss) in the output becomes smaller. The cost function in Equation (15) is calculated, from forward propagation of electronic density n(r) to an output of the DNN in terms of coefficient vector \vec{c}[n](r), which permits the determination of the system energy value. The cost function in Equation (15) may be optimized with any suitable methods, including, but not limited to, gradient descent. A gradient of the cost function in Equation (15) is calculated with respect to the parameters of the DFT module 120, and a gradient descent algorithm (e.g., stochastic gradient descent, batch gradient descent, and mini-batch gradient descent) is used to update the parameters to reduce the cost function.

Steps 502 to 508 may be performed iteratively, so that the cost function in Equation (15) is converged, minimized, or, alternatively, a predefined number of iterations has been achieved.

At 510, if the cost function has converged or a predefined number of iterations has been reached, the trained weight values are stored, and the DFT module 120 is considered to be sufficiently trained for application. Upon completion of training method 500, the DFT represented by the DFT module 120 may be conceptualized as:

E_{XC}[n]—∫f_{θ}[n](r)·\vec{E}[n](r)d³r, Equation (16)

Where \vec{E}[n](r)=(E₁[n](r), E₂[n](r), . . . , E_{N}[n](r)).

The trained DFT module 120 may then be deployed onto the classical processing module 102 of FIG. 1 to perform determination of system energy by DFT, as discussed above.

Other methods of training a DNN may also be adopted, including using a generative adversarial network (GAN), which is a deep learning model. A GAN includes at least two modules, one module being a generative model (also referred to as a generator), and the other module being a discriminative model (also referred to as a discriminator). These two models compete with each other and learn from each other so that a better output is generated. The generator and the discriminator may both be neural networks, and may be specifically DNNs or convolutional neural networks (CNNs).

Although the present disclosure may describe methods and processes with steps in a certain order, one or more steps of the methods and processes may be omitted or altered as appropriate. One or more steps may take place in an order other than that in which they are described, as appropriate.

Although the present disclosure may be described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method comprising:
receiving, at a density functional theory (DFT) functional module, an electronic density of a physical system; and
determining, by the DFT functional module, from the electronic density, parameters of a DFT functional that model one or more aspects of the physical system, wherein the DFT functional module is trained using training data, the training data including classical data generated from a quantum processing module.

2. The method of claim 1, wherein the training data includes a data pair comprising a training electronic density and a training exchange-correlation energy.

3. The method of claim 1, wherein the generating of the classical data by the quantum processing module further includes:
constructing a Hamiltonian of the physical system;
mapping fermionic operators of the Hamiltonian to qubit operators;
constructing, from the qubit operators, a set of unitaries;
applying the set of unitaries in accordance with a quantum algorithm onto one or more qubit registers; and
generating the classical data.

4. The method of claim 3, wherein the classical data includes one or more of an electronic density function, a total system energy, a classical shadow, and a reduced density matrix.

5. The method of claim 1, further including approximating the DFT functional using a Kohn-Sham method, wherein the DFT functional is parameterized using a hybrid functional construction.

6. The method of claim 5, wherein the hybrid functional construction is one of an internal method where the DFT functional, represented by E_{XC}, is expressed as
$${E}_{XC} = \int {\sum }_{i = 1}^{N} {c}_{i} {E}^{( i )} [ n ] ( r ) {d}^{3} r$$
and an external method where the DFT functional is expressed as
$${E}_{XC} = {\sum }_{i = 1}^{N} {c}_{i} \int {E}^{( i )} [ n ] ( r ) {d}^{3} r = {\sum }_{i = 1}^{N} {c}_{i} {E}^{( i )} ,$$
wherein the coefficients cᵢ are the parameters of the DFT functional.

7. The method of claim 3, wherein the Hamiltonian is constructed based on one of a first quantization formalism and a second quantization formalism.

8. The method of claim 7, wherein the Hamiltonian is constructed based on the second quantization formalism, and the fermionic operator to qubit operator mapping is based on a Jordan-Wigner transformation.

9. The method of claim 3, wherein the quantum algorithm is any one of quantum phase estimation, variational quantum eigensolver (VQE), adiabatic quantum algorithm, Krylov subspace method, and imaginary-time evolution.

10. The method of claim 3, wherein the quantum algorithm is quantum phase estimation, and the applying further includes:
preparing at least one auxiliary qubit in an equal superposition state;
applying each unitary U of the set of unitaries in the form of U²^{^{t}}, where t is the number of the at least one auxiliary qubit, onto each of the at least one auxiliary qubit;
applying an inverse quantum Fourier transform on each of the at least one auxiliary qubit;
measuring each of the at least one auxiliary qubit in a computational basis to generate an output bit string;
estimating a phase value based on the output bit string; and
determining a ground-state energy value based on the estimated phase value.

11. The method of claim 2, wherein the training of the DFT functional module further includes:
iteratively performing:
sampling the training data,
obtaining a predicted exchange-correlation energy based on the training electronic density,
calculating a loss value between the predicted exchange-correlation energy and the training exchange-correlation energy, and
updating a weight matrix of the DFT functional module based on the loss value; and
storing the updated weight matrix of the DFT functional module.

12. A system comprising:
a quantum processing module configured to generate classical data for training a density functional theory (DFT) functional module; and
a classical processing module configured to:
generate, by providing an electronic density of a physical system as input to the DFT functional module, parameters of a DFT functional that are used to model one or more aspects of the physical system.

13. The system of claim 12, wherein the DFT functional module is a trained deep neural network.

14. The system of claim 13, wherein the parameters of the DFT functional are weights of the trained deep neural network.

15. The system of claim 12, wherein the quantum processing module is based on any one of superconducting qubits, photonic qubits, trapped-ion qubits, silicon-based qubits, and neutral-atom-based qubits.

16. The system of claim 12, wherein the DFT functional module is trained using training data, the training data including the classical data, and the quantum processing module is configured to generate the classical data by:
constructing a Hamiltonian of the physical system;
mapping fermionic operators of the Hamiltonian onto qubit operators;
constructing, from the qubit operators, a set of unitaries;
applying the set of unitaries in accordance with a quantum algorithm onto one or more qubit registers; and
generating the classical data.

17. The system of claim 16, wherein the classical data includes one or more of an electronic density function, a total system energy, a classical shadow, and a reduced density matrix.

18. The system of claim 12, wherein the DFT functional is parameterized using a hybrid functional construction, the hybrid functional construction being one of an internal method where the DFT functional, represented by E_{XC}, is expressed as
$${E}_{XC} = \int {\sum }_{i = 1}^{N} {c}_{i} {E}^{( i )} [ n ] ( r ) {d}^{3} r$$
and an external method where the DFT functional is expressed as
$${E}_{XC} = {\sum }_{i = 1}^{N} {c}_{i} \int {E}^{( i )} [ n ] ( r ) {d}^{3} r = {\sum }_{i = 1}^{N} {c}_{i} {E}^{( i )} ,$$
wherein the coefficients cᵢ are the parameters of the DFT functional.

19. The system of claim 16, wherein the Hamiltonian is constructed based on one of a first quantization formalism and a second quantization formalism.

20. The system of claim 16, wherein the quantum algorithm is any one of quantum phase estimation, variational quantum eigensolver (VQE), adiabatic quantum algorithm, Krylov subspace method, and imaginary-time evolution.
